(19) United States
(12) Patent Application Publication
(10) Pub. No.: US 2003/0040964 A1
(43) Pub. Date: Feb. 27, 2003

(54) Loyalty currency vending system

(76) Inventor: Mark A. Lacek, Edina, MN (US)

Correspondence Address: INTELLECTUAL PROPERTY GROUP, FREDRIKSON & BYRON, P.A., 4000 PILLSBURY CENTER, 200 SOUTH SIXTH STREET, MINNEAPOLIS, MN, 55402, US

(21) Appl. No.: 10/197,217

(22) Filed: Jul. 17, 2002

Related U.S. Application Data
(63) Continuation-in-part of application No. 09/714,857, filed on Nov. 16, 2000.

(51) Int. Cl. G06F 17/60

(52) U.S. Cl. 705/14; 705/26

(57) ABSTRACT

A loyalty program tracking and conversion system that permits users to enter relevant information and data regarding frequent flyer or other loyalty programs whereby the system stores the information regarding the status of award points under the programs. The user can access this information via a communications network such as the Internet as well as shop for products and services from a variety of retailers. The system calculates an equivalent number of universal or system credits based on the award points from the various loyalty programs registered by the user. The user can use the credits to reduce the price of the products and services purchased through the system. These credits may be purchased for one's own account or for others, transferred between accounts for a fee, and may also be purchased by business entities as incentives or considerations for employees or customers.

### CROSS REFERENCE TO RELATED APPLICATIONS

This application is a continuation-in-part of and claims prior to, and hereby incorporates in its entirety herein, U.S. Application Ser. No. 09/714,857, filed Nov. 16, 2000.

### FIELD OF THE INVENTION

The present invention relates to tracking of loyalty programs points and conversion of points earned or accrued under such loyalty programs. The present invention allows for the application of such points towards the purchase of products and services from various retailers.

More specifically, the present invention may provide for an Internet website that allows the owner of points awarded by means of a loyalty or frequency program to compile and track award points from multiple programs and to convert such points into a universal credit or “currency” that can be applied towards the purchase of products and services from a variety of retail establishments or various service providers.

### BACKGROUND OF THE INVENTION

Many people are members of one or more loyalty programs. Also known as frequency or loyalty programs, these programs award “points,” “miles” or other credit to the members of the programs in exchange for, or based upon, the purchase of products or the use of services offered by the sponsors of the program. In some loyalty programs, the program sponsor will partner with other providers of products or services and points will be awarded based upon the use of the products or services of the partners as well.

A common example of such loyalty programs is the frequent flyer programs offered by airlines. In these frequent flyer programs, members of the program that fly on the sponsor airline or that use the lodging, transportation, or other services of the airline's partners will be awarded points. When a member has accumulated a sufficient minimum number of points, the member can then exchange the points for airline tickets or other benefits on the sponsor's airline or affiliates.

Typical loyalty programs, such as airline frequent flyer programs, can have limited use for many members. For example, under most frequent flyer programs, points are awarded whenever a member travels on the sponsor's airline. These points are awarded based upon the distance traveled by the member. However, the programs require the accumulation of a large number of points before the points can be redeemed for free air travel. For travelers that do not fly regularly, a large amount of time will occur before the member is able to accumulate sufficient points to receive the free travel benefit. Furthermore, under some programs, the awarded points may expire if not redeemed within a specified timeframe. Thus, a member who does not travel frequently may be in jeopardy of losing their points.

Another disadvantage of frequent flyer programs is that the obtained level of points or miles can typically be redeemed only for a free airline ticket. Additionally, the only airline for which the ticket can be redeemed is the airline sponsoring the program or its affiliates. Thus, the awards for which the member can redeem the points are extremely limited.

Another disadvantage of frequent flyer programs is the limited number of seats that airlines make available for free travel. If a member does get to the appropriate number of points, there is no guarantee the points will be redeemable for a particular flight as desired by the member.

Another disadvantage of frequent flyer programs is that awarded points under one program cannot be transferred or used to accumulate awards towards most other frequent flyer programs. Thus, a member that does not consistently fly a single airline may be further hindered in reaching the required point or mile levels to redeem the miles for free travel. However, if a member attempts to consistently fly a specific airline, they will be limiting their flight choices and may also be paying a higher fare than they could obtain on a different airline.

Additionally, as each frequent flyer program is operated by a different sponsor and each frequent flyer program operates under its own specific set of policies, rules and regulations, members are responsible for verifying and monitoring their own points in each separate program in which they are enrolled. As each program operates autonomously, such monitoring can be difficult, inconvenient, and cumbersome.

To aid in frequency program account monitoring and maintenance, many of the sponsors of loyalty programs allow members to access general information concerning the member's account via a World Wide Web page on the Internet. However, as each program is run separately and is not affiliated with the other programs, the specific loyalty program web pages must generally be accessed separately by the member.

While the previous discussion focuses on airline frequent flyer programs, it will be appreciated that the characteristics and disadvantages of such programs can apply to any type of loyalty or frequency program. The examples involving frequent flyer programs are, however, illustrative of drawbacks of existing frequency programs.

In light of the numerous disadvantages and difficulties associated with loyalty programs, there is a need for a system in which points awarded under various loyalty programs could be tracked and combined to be applied towards a variety of additional awards. Furthermore, there is a need for expanding the types of products or services to which the awarded points can be applied. There is also a need for providing easy shopping and purchasing of the award products and services and eliminate requests for block use of miles and/or points.

### SUMMARY OF THE INVENTION

The present invention relates to a system of tracking, computing and redeeming points awarded under a variety of individual loyalty programs. Access to the system is provided to users, particularly registered members, via a computerized communications network, such as the Internet. For example, the system may be implemented so as to be viewable via the www application over a TCP/IP connection.

The present invention meets the needs outlined above by using, for example, a World Wide Web site on the Internet to allow members of different loyalty programs to easily access information concerning their individual loyalty program points, to track the accumulation of these points and to convert the points at some point in time after they are accrued into a universal credit or “currency” that can be applied towards the purchase of a wide variety of products and services.

Once a user accesses the system, they are allowed to register to take advantage of the system or to sign in if they are existing members of the system. Based upon the information provided by the user, the user's award points under any number of participating loyalty programs will be tracked by the system and information concerning the availability of the points under each program can be provided to the user.

By accessing the system's user service, e.g. a web site, and then accessing an affiliated retailer's web site, a user can browse through information concerning the various products and services offered by the retailer towards which awarded miles or points can be applied either for purchase of products or services, or to receive a discount on such purchase. Generally, retailers may be motivated to offer goods or services through the system as a mechanism of marketing or advertising, for example, or to take advantage of market differentiation, in a manner similar to coupons or group discounts. Preferably, each retailer will determine what appropriate amount of miles, points, or discount can be applied toward each purchase. The system may convert the user's loyalty program award points into a universal credit or currency either at the time that the user chooses to purchase a particular product or service, or prior to the user purchase decision. This credit or currency can then be used as a form of payment toward the price of the products or services that the user desires to purchase. When the member purchases the product or service and upon authorization by the user, the system deducts the applicable number of award points from the appropriate loyalty program specified by the user. The information concerning the user's points may then be updated in the system and the number of points used is at some time hence conveyed to the appropriate loyalty program for example, in a batch transmission.

The present invention further provides for a member to purchase points via an online order form at a predetermined price per point. The member can determine the total cost of the purchase via a drop down calculator function. Upon purchase completion, the member is sent a verification email confirming the purchase/deposit. The points are then posted to the member's account following the completion of the purchase, either in real-time or in a batch transmission.

The present invention further provides for a user to purchase points for another person using an online order form and having the points sent to them. The points could be purchased at a set rate per point. The user can determine the total cost of the points via a drop down calculator. The points would be posted to the recipient's account soon after the purchase transaction if the recipient's account number or name is known and specified. Further, a menu of electronic gift cards can be made available to send to the recipient. In another embodiment, points could also be sent as a gift to an email address if the recipient is not a member. If the recipient is not a member, then the recipient may be prompted to register to become a member and upon becoming a member would receive their gift points. Confirmation emails may be sent to the member following the purchase and to the recipient upon deposit. Email recipients can claim their gift points using, for example, their last name and a unique confirmation code given after the recipient enrolls to be a member and is assigned an account number. Points are posted immediately after the claim code is redeemed. Preferably, to purchase gift points neither the purchaser nor recipient has to be a member. However, prior to redeeming the gift points claim code, the recipient preferably must join and receive an account number to redeem. The present invention further provides for a member to transfer points to other people via an online transfer form at a rate per point or a set fee. The transferor can determine the total cost via a calculator function. Upon completion, both the transferor and transferee may be sent an email verification confirming the transaction/deposit. The points are posted to the transferee's account after the completion of the transaction immediately by a real-time link or in a batch transmission. In another embodiment, the recipient does not have to be a member. However, prior to accepting the point transfer, the recipient must enroll and receive an account number. Further, base members can purchase, or subscribe to an upgraded status within a loyalty program system (e.g., an elite membership) via an online form for a fee. Their membership status may, for example, be upgraded for a 12-month period following the status change.

The present invention further provides for an organization to purchase points at a set rate per point using an online application and order process. The organizations could, for example, use the points as performance incentives, customer rewards, incentives, or as components of compensation. The organization first completes an online application and agrees to terms via an acceptance agreement. Once the organization is approved, they choose an email confirmation along with an organization ID/Password. They can then complete the online purchase form and receive points, which may be allocated or awarded to employees, customers, etc. The points may be ordered in multiple forms; for example, as paper certificates or electronic units. A calculator may be provided to enable the buyer to determine the total cost. Paper certificate orders may generate a message to a printer of a fulfillment vendor if the fulfillment or certificate orders are to be outsourced. The purchased points are posted and stored in an administrative account. To administer performance programs, organizations purchasing online through the program can use their organization's ID/Password. Administrators can login and access this administrative function to maintain the account, e.g., check balances, allocate points, and specify how the organization's name appears on the statement. Once allocated by an organization's administrator, points are posted to the recipient's account immediately by a real-time link or in a batch transmission. The point purchase site may preferably include a “how to use” marketing guidance page for prospective customer or subscribing companies.

### BRIEF DESCRIPTION OF THE DRAWINGS

FIG. 1 is an architecture and state diagram of one embodiment representing the application of the present invention.

FIG. 2 is a state diagram representing the registration process of the present invention.

FIG. 3 is a state diagram representing the sign-in process of the present invention.

FIG. 4 is a state diagram representing the retail transaction process of the present invention.

FIG. 5 is a state diagram representing the point purchase/transfer process of the present invention.

### DETAILED DESCRIPTION OF THE INVENTION

To assist in an understanding of the invention, a preferred embodiment or embodiments will now be described in detail. Reference will be frequently taken to the figures, which are summarized above. Reference numerals will be used to indicate certain parts and locations in the figures. The same reference numerals will be used to indicate the same parts or locations throughout the figures unless otherwise indicated.

The present invention concerns a system for tracking and converting points awarded under independent or disparate loyalty programs into a universal credit or “currency” and applying the credit or currency towards the purchase of a variety of products and services or otherwise providing a discount toward the purchase on the basis of the credits. The system is available and accessible by users, particularly registered members, through a computerized communications network such as the Internet. The system will be described in the context of the Internet, i.e., transmissions over a TCP/IP or lPv6 protocol connection, although the invention may also be implemented in other network or communication applications and network protocols, including voice telephony.

Users through any appropriate Internet or data communications means including voice telephony/POTS can access the system. In the preferred embodiment, users access the system on the Internet via one or more web pages implementing the system, as described herein in further detail. Users could also access the system via the Internet web pages of affiliated retailers and/or loyalty program sponsors participating in the system.

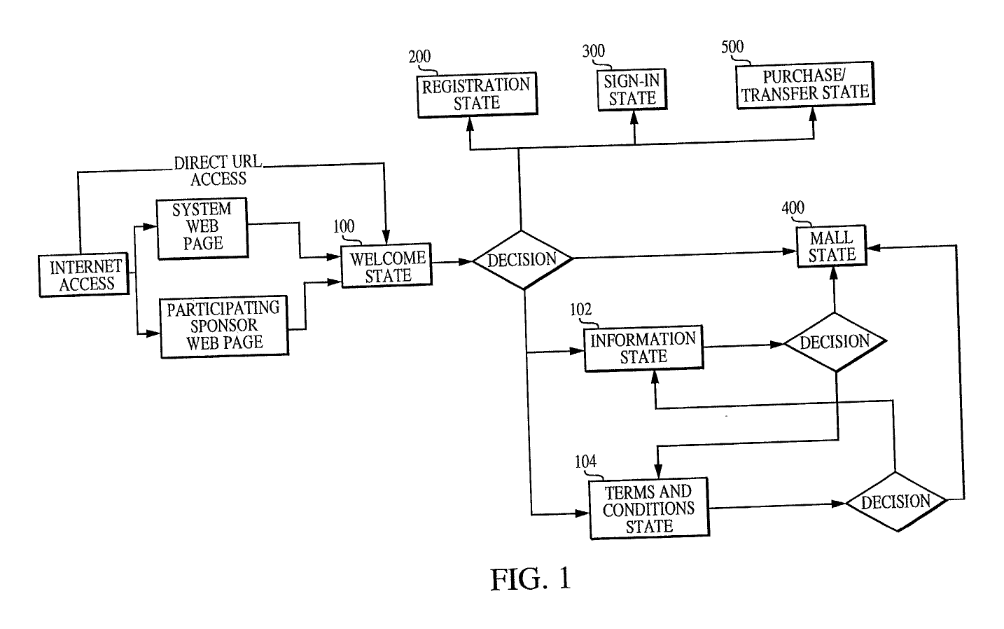

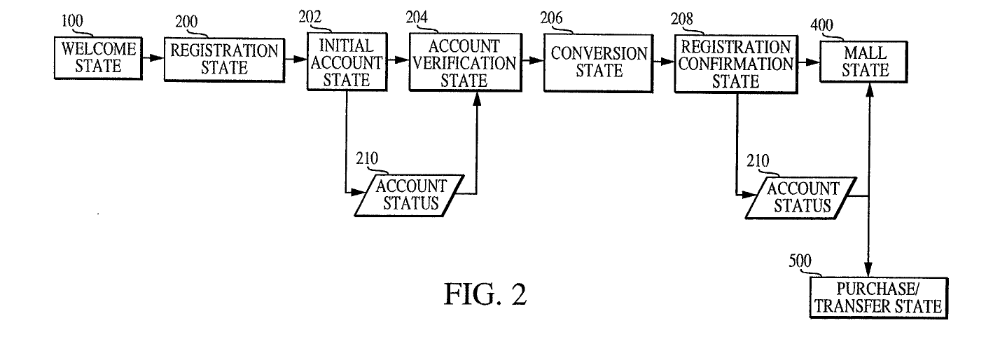

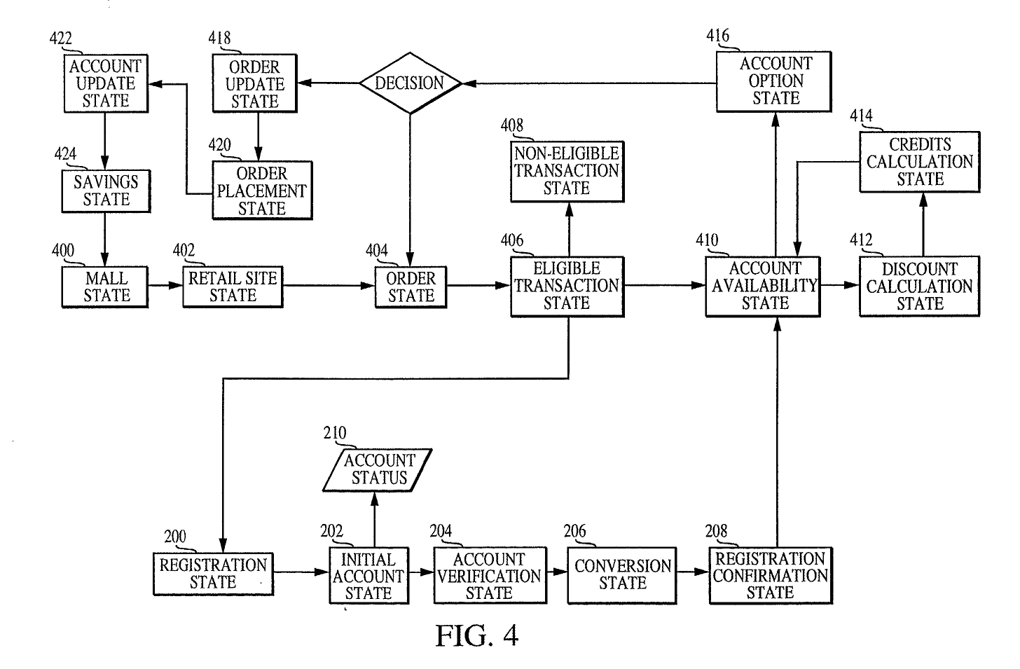

The system and the procedures for tracking and converting award points are illustrated in FIGS. 1-4 through the use of state diagrams. FIG. 1 depicts the overall architecture and state transitions of the system. It can be seen in FIG. 1 that the system can be broken down into several subordinate flows or substate diagrams. These are depicted in FIGS. 2-4.

In FIG. 1, state 100 depicts the initial or Welcome State encountered by the user entering the system by means of, e.g., an Internet web page established for the system. This Welcome State 100 would be encountered, and the welcome screen viewed by the user, if the user enters the system, for example, by the web page established as the system home page by the system's administrator. The user through other routes could also encounter Welcome State 100. For example, other URL web addresses could be established that, when entered and resolved by a name server, automatically direct the user to a server implementing Welcome State 100 of the system. Alternatively, other Internet web pages could provide a link to Welcome State 100.

Welcome State 100 provides several options for the user. Typically, Welcome State 100 would include information concerning the system such as how the system operates and the loyalty programs and retailers sponsoring, affiliated with or otherwise involved in the system.

As the system is described, it will be appreciated that at various states, certain information could be provided directly at a particular state or, in the alternative, the information could be provided at a separate state. A connection, such as an http/HTML hypertext link, could be provided between the states. Such connections allow the user to easily obtain the linked information.

In an embodiment of the present invention depicted in FIG. 1, if the user wishes to view information concerning the system, the user can indicate this desire, for example, by clicking on the appropriate HTML link. By, for example, executing HTML links, getting HTML pages and forms, and posting to CGI scripts or executable routines located on a remote server, the user may proceed to Information State 102. Information State 102 may provide a variety of information concerning the system. Information State 102 also allows the user to return to Welcome State 100 or to proceed to Mall State 400.

In the preferred embodiment, Welcome State 100 also allows the user to obtain via, e.g., HTML pages, specific information concerning the system. Such specific information could include, for example, the terms, conditions and regulations governing qualifications for becoming users or members of the system, information concerning qualification of award points and conversion into credits, and regulations governing purchasing transactions and credit or currency applications to such transactions.

If the user of the system desires information on specific regulations, the system proceeds to Terms and Conditions State 104. In the preferred embodiment, Terms and Conditions State 104 can be accessed through either Welcome State 100 or Information State 102. Also in the preferred embodiment, from Terms and Conditions State 104 the user can return to Welcome State 100, proceed to Information State 102 or proceed to Mall State 400.

In the preferred embodiment, Welcome State 100 contains several additional options. These options include allowing the user to register and enroll in the system. This option would be appropriate for users encountering the system for the first time and that wish to register and enroll in the program. This option would also be appropriate for unregistered users that have viewed the system previously but up to this point have not enrolled in the system.

Another option available on Welcome State 100 would be allowing the user to proceed to sign in with the system. This option would be appropriate for users that are already registered and enrolled in the system and that wish to obtain information concerning their award points or system credits or that wish to shop at retailers linked to or accessible via the system.

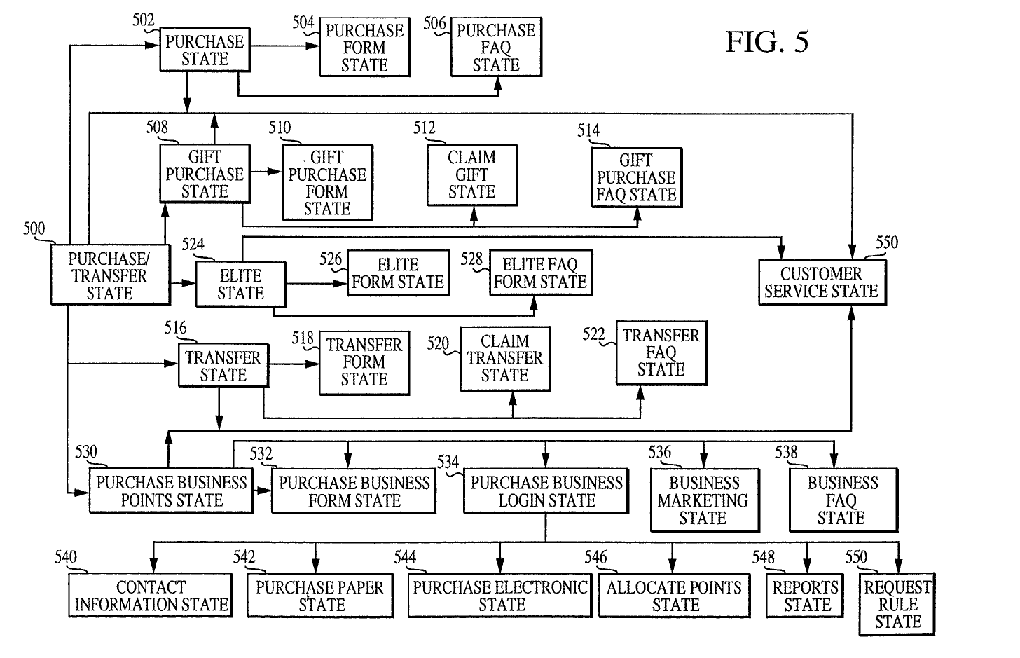

Another option preferably provided within Welcome State 100 would be to allow the user to proceed directly to Mall State 400. This option could be appropriate either for users that are not registered with the system or users that are registered with the system. At Purchase/Transfer State 500 the user can have several options pertaining to point-based transactions, however, in a preferred embodiment the options consist of a purchase option allowing individual members to purchase points for self-use or for another member, a transfer option allowing individual members to transfer point balances between them or non-members, an option to purchase an elite member status, or if the user represents a company or organization, a purchasing option where the company/organization can purchase points and assign them to a third party for sales programs, customer promotions, or employee recognition programs. Preferably a member could access the internet-enabled point sale programs at Purchase/Transfer State 500 through a link appearing on the system's web page site frame. These options are discussed in detail below with reference to FIG. 5.

FIG. 2 depicts a state transition diagram showing a procedure for an unregistered user to register with the system after initially entering the system through Welcome State 100. The initial state of the registration process is shown as Registration State 200. At Registration State 200, the user provides information as requested by the system. This information could include, but is not limited to, the name and address of the user, and a unique identification code and password or other authentication data such as a digital certificate or biometric data. The information may then be recorded with the system and the user may then proceed to Initial Account State 202.

At Initial Account State 202, the user enters information concerning the eligible loyalty programs in which the user is a participating member. For example, the user could be enrolled in one or more airline frequent flyer programs, hotel frequent lodging programs and car rental frequent renting programs. For all loyalty programs that are eligible for participation in the system, the user enters appropriate information at Initial Account State 202. This information could include the name of or company sponsoring the loyalty program, the name of the user as it appears on each eligible loyalty program, the user's account number for each such program, and any PIN or authentication data of the user.

In the preferred embodiment, a menu listing of all loyalty program partners participating in the system is provided to the user through the use of pull-down menus. This allows the user to easily see all of the participating loyalty program sponsors or partners, click on the appropriate sponsor, and then enter the appropriate information concerning that program.

After the user enters all of the required information concerning the loyalty programs of the participating sponsors that the user wishes to include in his or her system profile, the information is confirmed for accuracy. This confirmation can be performed in a variety of manners. In the preferred embodiment, the system electronically communicates with each sponsor that the user has requested for inclusion. This communication could be performed by the system accessing the Internet website of each designated sponsor in order to obtain and confirm the user's information.

In addition to verifying the account information of the user for each designated sponsor, the system also either obtains or verifies the amount of available award points the user has been awarded by each participating sponsor. This information may then be stored along with other user information in Account Status State 210.

The system may then, for example, proceed to Account Verification State 204. If the information provided by the user cannot be verified by the system, the user may be returned to Initial Account State 202, and, if desired, asked to reenter or correct the information that could not be verified. If the information is verified by the system, the information is stored at Account Status State 210.

Once the registration and account information of the user has been verified, the system may collect award points or other appropriate current points awarded to the registered user by each loyalty program sponsor and calculate the equivalent value of each point or mile. The system may then calculate the total number of points awarded by each sponsor into a single unit system credit or other value unit at Conversion State 206. This information concerning the credits is then transferred and stored at Account Status State 210.

After calculation of the user's award points into a uniform system credit or currency, the user may proceed to Registration Confirmation State 208 where the user may be informed that his or her registration has been confirmed. The user can then proceed to Mall State 400.

In a preferred embodiment, a user only has to enter registration information into the system once and may then be regarded as a system “member”. The system preferably allows the user or member to add or delete loyalty programs to be available through the system at any time. The relevant information concerning additional loyalty programs, such as name, and verification and authentication information can be verified at the time the new loyalty programs are added by the user.

In addition to increasing the ease of use of the system by a user, this feature also results in the verification of the user's account and credits information taking place prior to the user engaging in a transaction. In this manner, verification may be relatively transparent to the user, so that the transaction is not slowed down or delayed by the verification process. This verification process also allows for the user's transaction to occur even if the loyalty program sponsor site is unavailable at the time of the transaction, since the information from the sponsor site has already been gathered and verified. Also in a preferred embodiment, the system allows the user to access or update his or her profile information at any time.

It will be appreciated that throughout the system, the user may exit the system at any time. The exit feature could be achieved in a variety of manners. For instance, an exit command could be provided at one or more interfaces, e.g., HTML pages within the system. The user could then exit the program by activating this command. In one embodiment, after activating the exit command, the user proceeds to a Confirmation State wherein the user's desire to exit the system is confirmed. This allows the user to remain in the system if activating this command was in error or the user changes his or her mind about exiting the system.

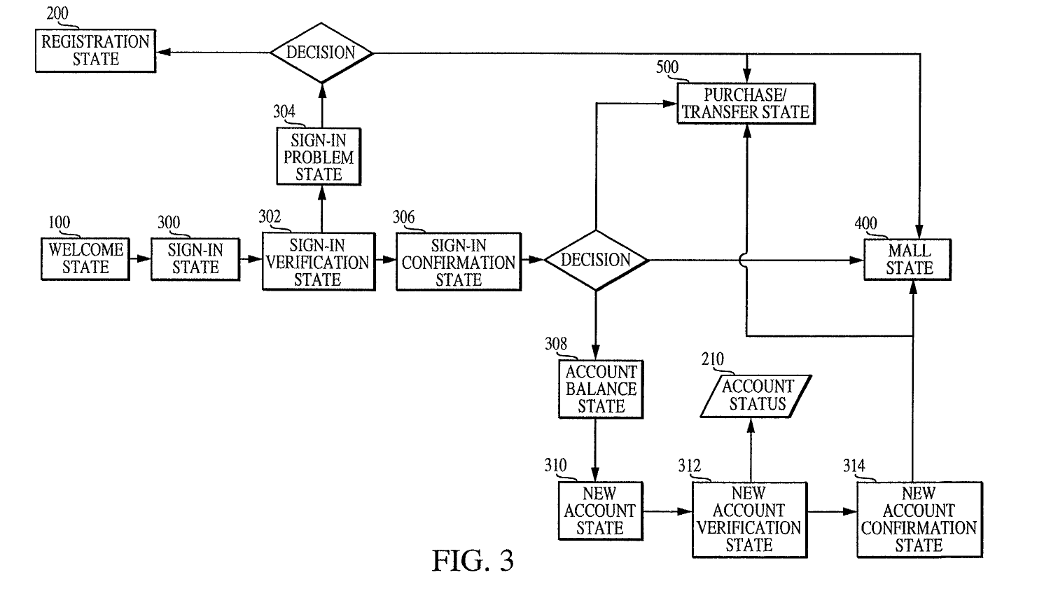

FIG. 3 depicts the states involved in the procedure for allowing a user that is already enrolled, e.g., as a “member”, in the system to sign into the system. At Sign-in State 300, the user is asked to provide appropriate identifying information. Such information would typically include the user's identification code and unique password or other authentication data. In a preferred embodiment of the subject invention, the login/authentication communication link and subsequent links are established using a secure protocol such as https, or another suitable PKI, tunneling, or key encryption scheme.

Once the user has entered the requisite information, the information is verified by the system at Sign-in Verification State 302. If the user's sign-in is not verified by the system at Sign-in Verification 302, the user is returned to Sign-in State 300 and asked to reenter the appropriate information. The system then attempts to verify the new information at Sign-in Verification State 302. If the system cannot verify the new information entered by the user, then the user is returned to Sign-in State 300 and again requested to enter the correct information.

In an alternate embodiment, the user is allowed a predetermined number of chances to enter the correct identification code and password. Once the user has reached the limit of chances to enter the correct information, the user proceeds to Sign-in Problem State 304. At Sign-in Problem State 304, the user can either attempt to determine the reason for the system failing to verify the user's information or proceed to other sections of the system such as Registration State 200 or Mall State 400.

In a preferred embodiment, once a user signs in, the user is given the option of having the system remember the user's identification code and password thereby allowing for easier sign-in by the user. The memorialization of the user's identification code and password by the system can be accomplished in the appropriate manner. For example, a cookie could be placed on the user's computer by the system for accessing at later times by the system.

Once the user's sign-in has been verified at Sign-in Verification State 302, the user proceeds to Sign-in Confirmation State 306. At Sign-in Confirmation State 306, the user can review his or her account information or proceed to shop at Mall State 400. If the user wishes to review his or her account information, the user proceeds to Account Balance State 308. At Account Balance State 308, information concerning the user's loyalty program partner accounts and related converted credits is displayed.

In the preferred embodiment, additional information concerning the user's award points is provided. This information could include the total points awarded by each of the user's loyalty program partners added together cumulatively, the total value of these points calculated as credits under the system, the purchases made to date by the user under the system and the total money saved by the user under such purchases.

If the user wishes to add additional loyalty programs to the system, the user proceeds to New Account State 310. At New Account State 310, the user is prompted to enter the information concerning the new account. This information is then verified at New Account Verification State 312.

In the preferred embodiment, verification of the new account information is performed in the same manner as the initial account verification under Account Verification State 204. That is, the system contacts the sponsor of the new loyalty program to verify the user's information and account balance. If the information cannot be verified, the user is returned to New Account State 310 or is allowed to proceed through the system until the information is verified. Under this latter scenario, the user will typically not be allowed to use the award points of the new program until all verification of the new program information has been obtained by the system.

Once the new account information is verified by the system, the number of award points under the program may be calculated by the system into the system's credit units and be made available for shopping. The information concerning the new loyalty program account may be stored within Account Status State 210. Additionally, upon confirmation of the new account information, the user proceeds to New Account Confirmation State 314.

Once a registered user or member has signed in to the system or an unregistered user has registered with the system, the user may proceed to Mall State 400. Similarly, an unregistered user may also proceed to Mall State 400. At Mall State 400 information concerning the stores participating in the system is provided to the user. This information includes a listing of all the stores participating in the system. In an alternative embodiment, the information also includes current discounts, bargains, or promotional items available to the user. Information on gift certificates available for purchase by the user in the system can also be provided.

In the preferred embodiment, the information concerning the participating stores can be organized and displayed in a variety of manners as determined by the user. For example, the stores could be organized into categories that could be displayed to the user based on entered criteria. Thus, the user could display stores in a desired category, such as clothing or appliances, or other categories, such as discount or exclusive stores.

Once a user selects a particular store, the user proceeds to Retail Site State 402. Retail Site State 402 would provide specific information concerning the products or services available for purchase by the user. Retail Site State 402 could be provided to the user in a variety of fashions. In one embodiment, the information concerning the products or services available for purchase by the user at the particular store chosen by the user would be assembled and presented to the user by the system. In an alternate embodiment, the user could specify particular types of products and the system would provide a listing of those products and the participating stores selling those products. In an alternate embodiment, the system would connect the user with the specific web page of the store chosen by the user.

At Retail Site State 402, the user could again search the products and services available for purchase from the particular store. If the user wished to purchase products or services from the store, the user would proceed to Order State 404. In order to purchase the product or service, the user follows the ordering procedure for the particular store chosen. When the user has completed the steps necessary for placing the user's order, the user proceeds to Eligible Transaction State 406.

At Eligible Transaction State 406, the system, or, in a preferred embodiment, a participating retailer's system may verify that the product or service to be purchased is eligible for use of the credits converted from the loyalty program partner award points in the system. If the transaction is not eligible for a discount, the user may be directed to Noneligible State 408.

At Noneligible State 408, the user may be informed of the fact that the transaction is not eligible for application of the system credits under the system and is asked if he or she wishes to continue with the purchase transaction, e.g., at full retail price. If the user wishes to proceed with the transaction, the user proceeds to Order State 404 where the sale of the product or service is completed. If the user does not wish to proceed with the transaction, the user can exit the system, return to Mall State 400 or Retail Site State 402.

If, at Eligible Transaction State 406, the transaction is determined by the system to be eligible for use of the credits converted by the system, the user proceeds to Account Availability State 410. However, if the user is not currently registered with the system, the user proceeds to Registration State 200 where they can register with the system.

At Registration State 200, the user provides information as requested by the system, such as name, address, identification code, and authentication data. The information may be recorded with the system and the user proceeds to Initial Account State 202.

For all loyalty programs that are eligible for participation in the system, the user enters appropriate information at Initial Account State 202, such as the name of or company sponsoring the loyalty program, the user's name, the user's account number and any PIN or other authentication data, if required. In the preferred embodiment, a menu listing of all loyalty program partners participating in the system is provided to the user through the use of pull-down menus.

In an embodiment in which a user is prompted to enter all of the pertinent information concerning the loyalty program partners to be included in his or her system profile, the information may be confirmed for accuracy. This confirmation can be performed in a variety of manners, as previously discussed.

The system also either obtains or verifies the number of award points the user has been awarded by each participating partner. This may be effected, for example, by a database query directed to a server hosting a participating partner's point database. This information is stored along with the user's other information in Account Status 210.

The system then proceeds to Account Verification State 204. If the information provided by the user cannot be verified by the system, the user is returned to Initial Account State 202 and asked to reenter or correct the information that could not be verified. If the information is verified by the system, the information is stored at Account Status State 210.

Once the registration and account information of the user has been verified, the system collects the frequent flyer miles, award points, or other appropriate unredeemed points awarded to the registered user by each loyalty program partner. The system calculates the total number of points awarded by each partner into the system credits at Conversion State 206. This information concerning the credits is then transferred and stored at Account Status State 210. After calculation of the user's award points into system credits, the user proceeds to Registration Confirmation State 208 where the user is informed that his or her registration has been confirmed.

At Account Availability State 410, current information regarding the user's award points under each loyalty program partner is displayed. The system proceeds to Credit Eligibility State 412. At Credit Eligibility State 412, the retail system determines whether the user's transaction is eligible for the use of the application of the system credits or currency. The system may then proceed to Credits Calculation State 414 and determine the number of system credits for which the transaction is eligible. The system then calculates the number of the award points under the loyalty programs of the partners that are required in order to achieve the desired discount by the user. After these calculations, the system proceeds to Account Availability State 410 and the amount of the corresponding number of awarded points needed for the transaction is displayed to the user.

The system then proceeds to Account Option State 416 where the user can determine if he or she wishes to use the available credits or discount offered. If the user chooses not to use the available credits or discount, the system returns the user to Order State 404 where the user can complete the transaction.

If the user wishes to use the available credits or discount offered, the user indicates which loyalty program sponsors the user wishes to use towards the transaction and the amount of award points from each loyalty program sponsor or affiliate to be used towards the credits. The system then proceeds to Order Update State 418 where the user's transaction is updated to show the credits applied to the purchase of the product or service and the updated cost of the transaction.

The system then proceeds to Order Placement State 420 where the final order is consummated and the order is placed with the retail store. After Order Placement State 420, the system proceeds to Account Update State 422. At Account Update State 422, the user's account information is updated to reflect the credits used by the user in the transaction to purchase the product or service. The system can also update the award points deducted from the appropriate affiliate sponsor accounts, notify the relevant affiliate sponsors or retailers and update the loyalty program points accordingly. This may be effected, for example, by database commands or instructions to servers hosting the loyalty programs database, or by SMTP or FTP transmissions to affiliate entities. Preferably, any communication with affiliate entities will be effected over a secure or encrypted channel, utilizing digital certificates and/or signatures. Communication between a system according to the present invention and affiliates may take place over, e.g., a TCP/IP connection, a dedicated line, direct dial-up connection, UDP transmission, or other network communication methods.

The system then proceeds to Savings State 424. At Savings State 424, the user's order is confirmed to the user. Additional information can be provided to the user as well. This information can include the current updated total award points held by the user in the system, the value of those total points in the system's credits, the amount of money saved by the user in the transaction through the credits applied by the system and the total amount of money saved by the user for all transactions under the system. The system then proceeds to Mall State 400 where the user can continue to shop.

In use, the system may provide for an effective and convenient means of allowing users to track loyalty program award points and applies the loyalty program award points towards the purchase of products and services from a wide variety of retailers. For illustration, in the following example, the program will be described in the context of frequent flyer programs.

As mentioned, the user can access the system in a wide variety of fashions. For example, the user could go to the Internet web site of the program or enter through the web site of a retailer participating in the program or through a sponsoring partner's web site. Once in the system, the user will be prompted to register with the program as a “member” or sign in if the user is already registered as a member.

If the user wishes to register, he or she may enter the information concerning user identification and authentication. The user may then be prompted to enter the information concerning the frequent flyer programs he or she wishes to include in the program, including the airline, membership number and any PIN or other authentication data. The system may then contact the web page of the indicated airline and verify the information entered by the user. The system may also obtain and store the information concerning the current balance of the user's frequent flyer points under each sponsor's program. The user can then proceed to the mall web page and shop. At the mall web page, the user can search the products available under the program or proceed to a particular store site.

Once the user wishes to purchase an item, he or she follows the procedures as specified by the particular retailer. The system then determines the eligibility of purchases for credits or discount application, the amount of the credits or discount that can be applied and the amount of award points needed to obtain such credits or discount. The user then selects the frequent flyer programs she wishes to use towards the purchase of the product and the number of award points from each program to apply towards the credits. The system then applies the credits towards the purchase of the product, deducts the points used to obtain the credits, and updates the status of the account balance accordingly.

FIG. 5 depicts a state diagram showing the procedure for a member or user to purchase or transfer points after initially entering the system through Welcome State 100. At Purchase/Transfer State 500 the user can have several options pertaining to point-based transactions, however, in a preferred embodiment the options consist of a purchase option allowing individual members to purchase points for self-use or for another member, a transfer option allowing individual members to transfer point balances between them or non-members, an option to purchase an elite member status, or if the user represents a company or organization, a purchasing option where the company/organization can purchase points and assign them to a third party for sales programs, customer promotions, or employee recognition programs. Preferably a member could access the internet-enabled point sale programs at Purchase/Transfer State 500 through a link appearing under the system's web page site frame.

Purchase/Transfer State 500 may preferably provide several options for the user. The user is able to purchase points for themselves, purchase gift points for another person, transfer their own points to another person, or email questions or comments to a customer service department. Further, companies and organizations may be presented with the opportunity to purchase points and use them as a performance incentive for sales programs, customer promotions, employee recognition, fund raising, a compensation component or attendant safety and attendance programs. This allows a loyalty program member to obtain points without e.g., traveling on a sponsor's airline or however else program points are accumulated. Therefore, if the loyalty program requires a certain number of points for free air travel, for example, and the member is short of that amount, then the user can simply purchase an amount needed to obtain free travel. Thus, travelers that do not fly regularly are able to accumulate sufficient points to receive the free travel benefit. Furthermore, if the awarded points are nearing their expiration date if not redeemed, the member can purchase extra points so that the points nearing expiration can be used and not lost.

At Purchase State 502 the user is given the opportunity to purchase points for his/her own personal use, email a question or concern to customer service, or view a list of frequently asked questions regarding the purchase of points or other available points transactions. Preferably, in order to purchase points at Purchase State 502 the user must be a registered member. Therefore, before the user can purchase points the member is asked to provide appropriate identifying information at Sign-In State 300 or is allowed to register at Registration State 200. After signing in or registering, the member can proceed with purchasing points at Purchase Form State 504. At Purchase Form State 504, prior authentication of the member is presumed, although an authentication request may be imposed as desirable at or prior to any state shown.

At Purchase Form State 504 the user can purchase points via an online order form, which the user fills out. The user preferably would input their member account number and then re-enter the member account number to verify the user has inputted it accurately. The user would also be able to select the amount of points they would like to purchase. In a preferred embodiment, the user may purchase up to a maximum annual cap (e.g., 6000 points) in 1000-point increments over a rolling 12-month period. The points may be priced at any suitable price as appropriate to the value of the consideration available with points and any revenue model thought to be appropriate for the program, and may or may not be a static fixed price, (e.g., $0.01 per point including any applicable taxes or per transaction handling fees; approximately $5 per 1000 points). A cap, if implemented, prevents the unwanted incentive or ability for members to get loyalty program rewards without using the service of the loyalty program sponsor. However, a maximum point cap may also be omitted, and the user could purchase as many points as desired in any increment, although preferably the point pricing structure will not allow users to circumvent or disrupt normal retail pricing structures in place for a service. In other words, a user typically would not be allowed to purchase a flight via point purchases alone, for less than buying the flight tickets at retail. Further, it is contemplated that the price for points could vary based on user, volume, or other parameters, all without departing from the spirit of the invention.

The user is able to determine the total cost of the points via a drop down calculator function. In another embodiment, the user is made able to determine the cost through cost indicators in parenthesis located next to the amount of points purchased. After the user has chosen the amount of points they wish to purchase the total cost may be presented next to the amount of points chosen. Finally, to complete the purchase of points, the user may be prompted to input their name, address, day and evening phone numbers, email address, possibly being confirmed by a duplicate entry, a credit card type, and the number and expiration date of the credit card number. The user then inputs the their order and their information is processed immediately. Upon purchase completion, the user is sent a verification email confirming the purchase/deposit. The points are then posted to the member's account almost immediately after the completion of the purchase if there is a real-time link or subsequently if a batch entry process is used. It is contemplated that purchasers who reach the calendar year cap (e.g., 6000 points) may retain excess points purchased via a stored value code (SVC) until it is determined that the user has not purchased/received more than 6000 points within a rolling 12 month period (e.g., a new cap term) or the user can transfer the points/SVC to another member for their use (discussed in more detail below).

At Purchase FAQ State 506 the member is able to view commonly asked questions and their answers regarding the purchase of points for individual members. Purchase FAQ State 506 is utilized to assist the member on making informed decisions regarding the purchase of points. In a preferred embodiment, if a question or comment is emailed or sent to customer service five or more times, then the question and its answer is automatically posted for viewing at Purchase FAQ State 506. If a question or comment is not addressed in Purchase FAQ State 506, then the user is able to email the question or comment at Customer Service State 550.

At Gift Purchase State 508 a user is given the option to purchase gift points, claim already purchased gift points, email a question or comment to customer service, or view frequently asked questions regarding the purchase and claiming of gift points. In a preferred embodiment, a user does not have to be a member in order to purchase points for another person. Therefore, a user does not have to register or sign-in in order to purchase points and can therefore continue to Gift Purchase Form State 510 without being rerouted to Sign-In State 300, Registration State 200, or other authentication procedure.

At Gift Purchase Form State 510, a user can purchase points for another person using an online order form and have the points sent directly to the person. Similar to Purchase Form State 504, a user inputs the amount of points desired to be purchased e.g., in 1000-point increments. Preferably there is a cap (e.g., 6000 points) during a set period (e.g., a rolling 12-month period). As stated, the points are preferably purchased at a predetermined rate per point plus applicable taxes (e.g., excise tax) and a optionally transaction-handling fee as determined by the program administrator. In addition, a user preferably may determine the total cost of the points via a drop down calculator.

A user may typically be required to enter their name, address, day and evening phone numbers, email address, a reconfirmation of the email address, a credit card type, and the card number and expiration date. Next, the user is required to enter the gift recipient's information such as their account number (if the gift recipient is a member and if their account number is known by the purchaser), and/or the recipient's name, account number, email address, and a reconfirmation of the email address. After completing the form, the information is processed and if the gift recipient is a member, the points are posted to the member's account promptly thereafter (if the member's account number was inputted). If the gift recipient is not a member or if the member's account number was not inputted, then the points are stored in the form of a stored value code for example. Further, a user may be presented with the option of sending an electronic gift card chosen from a menu of electronic gift cards to the recipient with the gift points. If the gift recipient is not yet a member or if the member's account number was not inputted, a claim code is sent with the gift to the recipient's email address. Once the gift recipient becomes a member with an established account the gift points are instantly transferred from the stored value code into the member's account by entering the stored code at Claim Gift State 512. Confirmation emails are sent to the sender following purchase and to the recipient upon receipt of the points or stored claim code in the member's account. Thus if a non-member receives gift points they will be sent an email confirmation when the points have been placed in a stored claim code and they will be sent an email confirmation when the points are moved to a registered account established when the non-member becomes a member. Email recipients can claim their gift points using their last name and the unique claim code. It is contemplated that the annual cap, rate per point, point purchase increments and tax rates may vary over time and can be set by the program administrator. Further, it is contemplated that email recipients who reach the annual cap may retain excess points purchased via a stored value code (SVC) until it is determined that the user has not purchased/received more than the maximum points within a 12 month calendar year period (e.g., a new cap term). Optionally, the user can transfer the points/SVC to another member for their use (discussed in more detail below).

At Claim Gift State 512 a member is able to collect their gift points. Typically a member would only have to go to Claim Gift State 512 if either the user that purchased the gift points did not know the member's account number or the gift recipient was not a member at the time of the gift purchase. This is because neither the purchaser nor point gift code recipient has to be a member until they wish to redeem the gift claim code. However, in a preferred embodiment, the recipient must join and receive an account number before claiming their gift. At Claim Gift State 512 the gift recipient would input their name, account number, and their claim code number. Once all this information is entered the gift points are instantly credited to the recipient's account. It is contemplated that the gift points would remain in an escrow account to be claimed for 1 year before the purchaser is given a new claim code and a notification via email that they have a predetermined time period to collect the gift points before the points are forfeited.

At Gift Purchase FAQ State 514 a user is able to view commonly asked questions and the answers regarding the purchase of points for third party recipients. Gift Purchase FAQ State 514 is utilized to assist the member on making informed and educated decisions regarding the purchase of points for other people. In a preferred embodiment Gift Purchase FAQ State 514 functions in a manner similar to Purchase FAQ State 506, in that if a question or comment is emailed or sent to customer service five or more times, then the question and its answer is automatically or manually posted for viewing at Gift Purchase FAQ State 514. If a question or comment is not addressed in Gift Purchase FAQ State 514, then the user is able to email the question or comment at Customer Service State 550.

At Transfer State 516 the user is presented with options such as transferring points to another person, emailing a question or concern to customer service, or viewing frequently asked questions regarding the transfer of points. At Transfer Form State 518 the user is able to transfer points to another person via an online transfer form at a predetermined rate plus applicable taxes and any per transaction handling fees. For example, it may cost ½¢ per point to transfer existing points from your account to another account.

At Transfer Form State 518 the member enters his/her member account number (optionally, the member may be prompted to re-enter the member account number to verify the user has inputted it accurately). The transferor then enters his/her name, address, day and evening phone numbers, email address, (and optinally a duplicate confirmation entry of the email address), and a credit card number with required card information, or other suitable payment information. Then, if one exists, the transferor can input a transferee's member account number, transferee's name, address, day and evening phone numbers, and email address. It is necessary that the transferor input the transferee's email address, home address, or account number or both in order to effectuate the transfer properly. For example, if a proper account number is entered, the transferee is a member, and the points can be directly inputted into the transferee's account. However, if the transferee is not a member or if the transferor does not know the transferee's account number, then an email or home address should be requested by the system in order to notify the transferee of the transfer and to give the transferee the transferred points claim code. All of the other transferee information can be entered at the transferor's option. This is because, similar to purchasing gift points, after completing the transfer form, the information is processed and the points are posted to the member's account almost immediately (if the member's account number was inputted) or to a stored claim code if the transferee is not yet a member or if the member's account number was not inputted. If the transferee is not yet a member or if the member's account number was not inputted, a claim code is sent to the transferee's email address. Once the transferee becomes a member with an established account the points are instantly transferred from the escrow account into the member's account by entering the necessary information at Claim Transfer State 520 discussed in more detail below. Confirmation emails are sent to the transferor following purchase and to the transferee upon deposit in both the member's account and if necessary an escrow account; email recipients can then claim their transfer points using authentication information, e.g., their last name and a unique claim code. It is contemplated that the annual cap, rate per point, transaction fee, point transfer increments and tax rates may vary over time and can be set by the program administrator. Further, it is contemplated that email recipients who reach the annual cap may retain excess points transferred via a stored value code (SVC) until it is determined that the user has not purchased/received more than maximum points within a prescribed period (e.g., a new cap term) or the user can transfer the points/SVC to another member for their use (discussed in more detail below). Similar to Purchase States 504 & 510 above, the transferor can determine the total cost of the transfer via a drop down calculator function.

At Claim Transfer State 520 a member is able to collect their transfer points. Typically a member would only have to go to Claim Transfer State 520 if either the transferor did not know the member's account number or the transferee was not a member at the time of the transfer. This is because the transferee does not have to be a member until they wish to redeem the transfer claim code. Then the transferee must join and receive an account number before claiming their transfer. At Claim Transfer State 520 the transferee would input their name, account number, and their claim code number. Once all this information is entered the transferred points may be instantly credited to the recipient's account. Again, the points can be kept in a stored value code for some set period, e.g., one year in a preferred embodiment, before the transferor is given an opportunity to reclaim the transferred points before they are forfeited.

At Transfer FAQ State 522 a user is able to view commonly asked questions and the answers regarding the transfer of points to third party recipients. Transfer FAQ State 522 is utilized to assist the member on making informed and educated decisions regarding the transfer of points to other people. In a preferred embodiment, if a question or comment is emailed or sent to customer service five or more times, then the question and its answer is automatically or manually posted for viewing at Transfer FAQ State 522. If a question or comment is not addressed in Transfer FAQ State 522, then the user is able to email the question or comment at Customer Service State 550.

At Elite State 524 base members have the option to purchase or subscribe to upgraded membership state, e.g., an “elite” membership, email a question or concern to customer service, or view frequently asked questions regarding becoming an elite or other premium/VIP member. Becoming an elite member upgrades the member's membership for a period of time, e.g., a 12-month period. This upgraded membership status may entitle the member to certain perks, such as being informed early of special purchase options, having a higher cap on the member's rolling 12 month point value cap (e.g., 12,000 points versus 6,000 points for base members), and receiving special discounts, flight upgrades, point bonuses or other promotions reserved only for elite members.

At Elite Form State 526 a member has the option to purchase an elite membership via an online form. The member may be prompted to input his/her member number, name and credit card number or other payment information. This information is then transmitted to an administrator who enables a change in the member's status indicator and provides an indicator for fulfillment by an external vendor. Upon completion of the charge transaction, change in status transmission could be via API, XML, or batch process using an agreed upon EDI format. Further, Elite Status FAQ State 528 allows a user or member to view frequently asked question concerning obtaining elite status, similar to FAQ States 506, 514, & 522 discussed above.

At Purchase Business Points State 530 a business has the option to purchase points, perform administrative tasks regarding their points and account, view marketing information explaining how the business points can be used, email a question or concern to customer service, or view frequently asked questions concerning the purchase of business points. Purchase Business Points State 530 is implemented as an incentive tool for businesses. The company/organization can purchase points for use in sales programs, customer promotions, employee recognition, fund raising, safety and attendance programs, and any other appropriate incentive program or compensation system available.

At Purchase Business Form State 532 points can be purchased at a predetermined rate per point plus applicable taxes and any transaction fees by a subscribing or approved company/organization using an online application and order process. A business can then use the points as performance incentives. For example, a business first completes an online application and acceptance agreement. This is comprised of inputting the business' name and an administrator for the points. The business then chooses whether they prefer to have the points issued in paper or electronic form, how many points are desired, and credit card information. Preferably, once the information is inputted a program administrator reviews the application to ensure there is no purchasing organizations (or programs) that conflict with partner agreements or brand association standards. Once the business is approved, they receive an email confirmation. They then, after payment by credit card or check, receive their points, which may be allocated or awarded to employees, customers, etc. In a preferred embodiment, a drop down calculator enables the buyer to determine the total cost, which can be paid using a valid credit card or check/invoice. It is further contemplated that price per point, minimum/maximum purchase levels (dollars and points), paper certificate expiration, e-points expiration, and participant point award minimums may vary between paper and electronic orders. Paper certificate orders generate an email to a fulfillment vendor. This is basically to notify the fulfillment vendor that a certain amount of points have been ordered by a certain business. This notification helps to prevent any fraudulent points from being redeemed with a fulfillment vendor. Points received by performance program individuals can be capped annually, similar to the 6000-point cap for individuals discussed above. However this cap may vary by purchasing organization. In a preferred embodiment there is a 200,000-point minimum purchase for electronic points and a 50,000-point minimum purchase for paper certificates of points. These minimum purchase amounts can be changed for all or a single organization at the discretion of the user.

In a preferred embodiment purchased points are posted and stored in an administrative account. At Purchase Business Login State 534 the business can administer their performance programs online through this administrative account. The business inputs their organization ID and password in order to access their administrative account. In a preferred embodiment only one person in the business has access to the ID/password to ensure accurate and consistent management of the administrative account. For example, administrators can login and access the administrative account to check balances, allocate points, and specify the organization's name to appear on the member statement (under a co-branding option). Once allocated by an organization's administrator, points are posted to the recipient's reward program account immediately if a real-time link or dedicated connection is available. A buying organization's administrator is automatically notified by email when “minimum available point” thresholds are reached to remind them to replenish points in their account as necessary. Preferably, organizations will have the option of inactivating their account.

At Contact Information State 540 a business is able to update the organization's contact information. Contact Information State 540 presents a form where the business can change the business name, change the account's administrator, switch from electronic certificate points to paper certificate points, or change the payment method. Further, similar to Purchase Business Form State 532 the business can change the business' official contact information such as the address, phone number, and email, and the business can change the amount of administrators in charge of the account, to an upper limit of three. These changes are then reviewed by a program administrator to once again ensure there is no purchasing organizations/programs conflict with partner agreements or brand association standards.

At Purchase Paper and Purchase Electronic States 542 & 544 a business is able to purchase points utilized in customer and employee rewards programs. The purchase option the business chose at Purchase Business Form State 532 (i.e., electronic certificate points or paper certificate points) determines whether the business will be able to enter Purchase Paper State 542 or Purchase Electronic State 544. If a business choose electronic certificate points in the payment options, then they will not have access to Purchase Paper State 542 and if a business chooses paper certificate points in the payment options, then they will not have access to Purchase Electronic State 544. Regardless of which Purchase State 542 or 544 is chosen the purchase form may be implemented in largely identical fashion. For example, at each Purchase State 542 or 544 the business' contact information, administrator information, purchase options, and payment options are listed from previously inputted information at Purchase Business Form State 532. All the business need to do is select an amount of points they wish to purchase, verify all the information listed is correct, and then submit the purchasing information. When submitted the information may be checked to ensure the business has not gone over a points cap set by the program administrator or that the business is current in paying their invoices. (Preferably, this is for individual purchase only). The difference between Purchase States 542 and 544 is that Purchase Paper State purchases generate an email to a fulfillment vendor to notify the fulfillment vendor that a certain amount of points have been ordered by a certain business. Further, the paper certificates are then either ordered from a printer or are printed on site and then sent to the business. Paper certificates include a unique claim code imprinted thereon and a website address where the recipient is directed to enter the code and claim/deposit the point award in their reward program account. Electronic certificates are kept in an administrative account and remain there until transferred to another account.

At Allocate Points State 546 a business is able transfer points to reward customers or employees. Similar to Purchase Form State 504, a business inputs the amount of points to be transferred. In a preferred embodiment the transfers are in 1000-point increments and preferably there is a cap (e.g., 50,000 points) per individual account per a rolling 12-month period. As stated, the points are preferably purchased at a predetermined rate per point plus applicable taxes and a transaction-handling fee as determined by the program administrator.

A business may enter the recipient's name, address, day and evening phone numbers, and email address. Next, the business may be prompted to enter the recipient's information such as their account number (if the recipient is a member and if their account number is known by the business), name, address, phone number, and email address. After completing the form, the information is processed and if the recipient is a member, the points are posted to the member's account almost immediately (if the member's account number was inputted). If the recipient is not a member or if the member's account number was not inputted, then the points are posted to an escrow account similarly to the gift purchase transaction discussed above. If the recipient is not yet a member or if the member's account number was not inputted, a claim code may be sent to the recipient's email address. Once the recipient becomes a member with an established account the points are instantly transferred from the stored value code into the member's account by entering the claim code at Claim Gift State 512. Confirmation emails are preferably sent to the business following purchase and to the recipient upon deposit of the points in either an escrow account and/or a member's account. Thus if a non-member receives gift points they may be sent an email confirmation when the points have been placed in an escrow account and they will be sent an email confirmation when the points are moved to a registered account. Email recipients can claim their points using their last name and the unique claim code. The points must be deposited into a valid account prior to the expiration date of the business' electronic escrow account (preferably three years from activation). In a preferred embodiment, points that expire prior to being deposited are automatically rendered invalid and will not be refunded or extended. There will preferably be no minimum per award transaction, but preferably a maximum, e.g., 50,000 points, may be deposited into an account in a calendar year.

The paper certificates points are preferably issued in 500, 1000, or 5000, and other points denominations. The business' name can be printed on the face of the certificates. Once received, the certificates must be deposited into a valid account prior to the expiration date printed on the face of the certificates (preferably one year from the date of issue). Certificates that expire prior to being deposited are automatically rendered invalid and will typically not be refunded or extended in order to reduce administrative burdens on the administrator of a system according to the present invention. Paper certificates include a unique claim code imprinted thereon and a website address where the recipient is directed to enter the code and claim/deposit the point award in their reward program account.

At Report State 548 a business is can determine how effective their rewards program is through detailed reports, graphs, and tables. The business will preferably be able to determine, for example, how many points have been purchased, how many points have been given out, who the points have been given to, where, when, and if the points have been used, and what vendors have the points been used with. With these reports a business is able to effectively examine if the rewards program if used for incentive purposes, for example, is having the intended effect.

At Request Rule State 548 a business is able to submit formal requests for exceptions to the rules of the program. For example, a business could submit a formal request to provide a loyal customer with more than 50,000 points in a one-year time frame because that customer has been especially lucrative or important to the business. Therefore Request Rule State 548 acts as an official channel to submit petitions for rule variances.

At Business Marketing State 536 a business can obtain “how to use” marketing guidance in best utilizing their rewards programs and achieving desired effects. Business FAQ State 538 allows a user to member to view frequently asked question concerning business points, similar to FAQ States 506, 514, 522, and 528 discussed above.

At Customer Service State 550 users can access customer service representatives/experts specializing, for example, in point purchase/transfer options and elite purchase options. In addition, there can be an FAQ section and an enrollment link to facilitate customer service. Further, in a preferred embodiment, all order forms mentioned above will include fields for basic marketing related survey inquiries, e.g., how the user came to find or arrived at the system implemented according to the present invention.

Preferably the system includes complete security, audit functionality, and standard reports for program administrators. Preferably security is enforced at time of transaction using account number and name validation routines. Upon customer request, exception handling can be used to manage the instances where a customer might inadvertently enter a valid number/name other than their intended number/name, e.g., that of their spouse. Preferably the system is hosted at a tier 1 facility with intrusion detection, firewalls, and suitable physical security, etc. As a further security precaution, the database preferably resides in a separate physical tier and can only be accessed by the application tier. The web tier can preferably only access the application tier. Therefore, the database is preferably not accessible from web server and the database may be accessed only via pass through of the application tier on a single account basis (i.e., one account at a time). Preferably all point cap and expiration rules are managed and validated through program administrators. Further, transactional history is maintained to enforce cap/expiration standards thus minimizing the administrative burden on the program administrators. As stated above, it is preferred to use a real-time link/dedicated connection to transfer/post point purchases on the database in order to improve data synchronization and system accuracy. Alternatively, batch data format requirements and transfer process could be employed according to typical EDI methods, e.g., FTP transfers daily or computer tape.

While a preferred embodiment of the present invention has been described, it should be understood that various changes, adaptations, and modifications might be made therein without departing from the spirit of the invention and the scope of the appended claims. For example, it will be appreciated that references to credit card payments may be replaced with any other suitable payment method, e.g., reward account debiting, electronic payment services, e-money systems, or the like.

What is claimed is:

1. A computerized method of purchasing loyalty program points over a communications network comprising the steps of:
(a) obtaining the number of award points awarded a user under at least one loyalty program;
(b) providing to the user an opportunity to purchase more award points over the communications network;
(c) converting the user's award points into a credit;
(d) providing to the user on-line access to at least one retailer that provides discounts for products or services based on said credit;
(e) calculating the discount off of the price of the product or service for which the user is eligible; and
(f) applying the discount to the price of the product or service purchased by the user.

2. The method of claim 1 further comprising the step of providing to the user an opportunity to purchase award points for a third party.

3. The method of claim 1 further comprising the step of providing to the user an opportunity to transfer award points to a third party.

4. The method of claim 1, further wherein the user is a business.

5. The method of claim 4, further comprising the step of providing to the business an opportunity to transfer award points to customers and employees.

6. The method of claim 3 wherein the step of converting the user's award points into a credit includes converting the user's award points from a plurality of loyalty programs of the user.

7. The method of claim 1 further comprising the step of providing to the user an opportunity to transfer award points over the communications network.

8. The method of claim 1 further comprising the step of transferring award points through a business promotion or sweepstakes over the communications network.

9. A computerized, networked loyalty program tracking and credits conversion system, comprising:
a database for maintaining the current credits balance of a user of the system;
an interactive communication link to a credit purchasing program to which the user can purchase credits;
an interactive communication link to a loyalty program to which the user subscribes;
an interactive communication link to at least one vendor of a product or service offered to the user; and
computerized means for the reduction of the credits balance, said reduction being approximately proportional to a discount offered to the user by a vendor.

10. The system of claim 9 wherein the credit purchasing program further allows the user to purchase credits for third parties.

11. The system of claim 9 wherein the credit purchasing program further allows the user to transfer existing credits to third parties.

12. The system of claim 9 wherein the user is a business.

13. The system of claim 12 wherein the credit purchasing program further allows the business to purchase credits and transfer said credits to customers and employees.

14. The system of claim 9 further comprising a computerized means for calculating the total cost of purchasing credits.

15. The system of claim 9 further comprising a communication link to inform the user that the purchase of credits was verified.
